(19) United States
(12) Patent Application Publication
(10) Pub. No.: US 2006/0041587 A1
(43) Pub. Date: Feb. 23, 2006

(54) Disk quota management with limits classes

(75) Inventors: Mark Allen Grubbs, Round Rock, TX (US); Grover Herbert Neuman, Austin, TX (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 10/920,908

(22) Filed: Aug. 18, 2004

(51) Int. Cl. G06F 17/00

(52) U.S. Cl. 707/104.1

(57) ABSTRACT

Methods, systems, and computer program products are provided for disk quota management. Embodiments include assigning a user to a limits class, receiving, from a user, a request to store a resource, and determining whether to allow the user to store the resource in dependence upon the limits class and current disk usage of the user. In some embodiments, determining whether to allow the user to store the resource in dependence upon the limits class and current disk usage of the user includes retrieving a user record for the user, retrieving a limits record in dependence upon the user record, and comparing the user's current disk space usage in the user record and the size of the resource with the disk space usage maximum in the limits record.

### BACKGROUND OF THE INVENTION

1. Field of the Invention

The field of the invention is data processing, or, more specifically, methods, systems, and products for disk quota management with limits classes.

2. Description Of Related Art

Disk quota management defines, maintains and enforces limits on the amount of disk space and the number of files that are allocated to individual users or groups of users sharing resources on a file system. To effectively manage disk space and file number quotas, a systems administrator typically must set and remove limits on disk space and warn users when they are approaching these limits. In some situations, the system administrator may also want to deny additional disk space to users who exceed these limits. In conventional disk quota management techniques, a system administrator must explicitly define the limits for each user on the system and the limit information is stored along with the actual usage data in user records for each user. These user records are stored in a flat quota file accessible to the file system. Despite the fact that a large number of users typically have the same limits, the limits information is stored in each user record and therefore often repeated for many users. Maintaining limits information in the user records results duplicating limits information in many user records and requiring a burdensome effort on the part of a system administrator to change the limits information in those user records. It would be advantageous to have a method for disk quota management with limits classes that separate a user's current disk usage information from a user's limits information.

### SUMMARY OF THE INVENTION

Methods, systems, and computer program products are provided for disk quota management. Embodiments include assigning a user to a limits class; receiving, from a user, a request to store a resource; and determining whether to allow the user to store the resource in dependence upon the limits class and current disk usage of the user. In some embodiments, determining whether to allow the user to store the resource in dependence upon the limits class and current disk usage of the user includes retrieving a user record for the user, retrieving a limits record in dependence upon the user record, and comparing the user's current disk space usage in the user record and the size of the resource with the disk space usage maximum in the limits record. In some embodiments, determining whether to allow the user to store the resource in dependence upon the limits class and current disk usage of the user includes retrieving a user record for the user, retrieving a limits record in dependence upon the user record, comparing the user's current stored file total in the user record and a requested number of resources to be stored with the file number maximum in the limits record.

Many embodiments include updating the limits record. In some embodiments, the limits record and the user record are stored in a quota file in a file system. In some embodiments, the limits record is stored in a limits file in a file system and the user record is stored in a quota file in the file system. In some embodiments, the limits record is stored as an extended attribute to a quota file in a file system.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 depicts an exemplary distributed data processing system capable of disk quota management with limits classes according to embodiments of the present invention.

FIG. 2 sets forth a block diagram of automated computing machinery comprising a computer useful in disk quota management with limits classes according to embodiments of the present invention.

FIG. 3 sets forth a line drawing of an exemplary quota file useful in implementing disk quota management in accordance with embodiments of the present invention.

FIG. 4 sets forth a flow chart illustrating an exemplary method for disk quota management.

FIG. 5 sets forth an exemplary method for determining whether to allow the user to store the resource that includes a determination as to whether storing the resource will exceed the user's allocated disk space.

FIG. 6 sets forth a flow chart illustrating an exemplary method for determining whether to allow the user to store the resource that includes a determination as to whether storing the resource will exceed the user's allocated number of files.

### DETAILED DESCRIPTION OF EXEMPLARY EMBODIMENTS

### Introduction

The present invention is described to a large extent in this specification in terms of methods for disk quota management with limits classes. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Disk Quota Management With Limits Classes

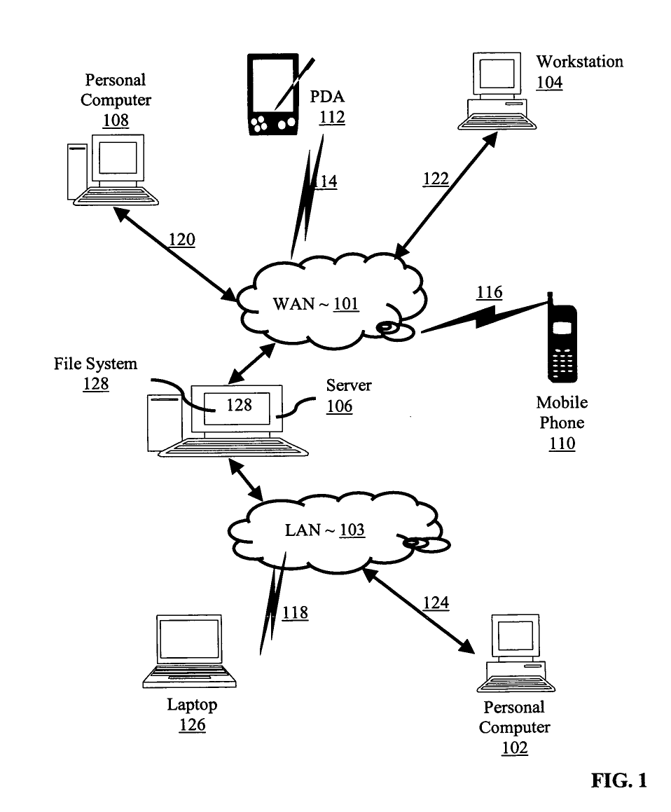

Exemplary methods, systems, and products for disk quota management with limits classes are now explained with reference to the accompanying drawings, beginning with FIG. 1. FIG. 1 depicts an exemplary distributed data processing system capable of disk quota management with limits classes according to embodiments of the present invention. The system of FIG. 1 includes a number of computers connected for data communications in networks. Each of the computers of the system of FIG. 1 may have access to a server (106) having installed upon it a file system modified in accordance with the present invention to enforce disk quota management with limits classes. The data processing system of FIG. 1 includes wide area network (“WAN”) (101) and local area network (“LAN”) (103). The network connection aspect of the architecture of FIG. 1 is only for explanation, not for limitation. In fact, systems having file systems to implement disk quota management with limits classes according to embodiments of the present invention may be connected as LANs, WANs, intranets, internets, the Internet, webs, the World Wide Web itself, or other connections as will occur to those of skill in the art. Such networks are media that may be used to provide data communications connections between various devices and computers connected together within an overall data processing system.

In the example of FIG. 1, the server (106) has installed upon it a file system (128) capable of disk quota management with limits classes that is made available to a plurality of client devices through server (106). The file system (128) of FIG. 1 operates generally by assigning a user to a limits class, receiving, from a user, a request to store a resource on the file system, and determining whether to allow the user to store the resource in dependence upon the limits class to which the user is assigned and the current disk usage of the user. In this specification ‘computer resource’ or ‘resource’ refers to any aggregation of information capable of being stored in a file system according to various embodiments of the present invention. The most common kind of resource is a file, but resources include dynamically-generated query results as well, such as the output of CGI (‘Common Gateway Interface’) scripts, Java servlets, dynamic server pages, documents available in several languages, and so on. In effect, a resource is somewhat similar to a file, but more general in nature. Resources implemented as files include static web pages, graphic image files, video clip files, audio clip files, and so on. As a practical matter, most resources are currently either files or server-side script output. Server side script output includes output from CGI programs, Java servlets, Active Server Pages, Java Server Pages, and so on. Server (106) may be any computer capable of supporting a file system in accordance with the present invention.

In the example of FIG. 1, several exemplary devices including a PDA (112), a computer workstation (104), a mobile phone (110), and personal computer (108) are connected to WAN (101) and allow users to access resources on, retrieve resources from, and store resources on the file system (128). Network-enabled mobile phone (110) connects to WAN (101) through wireless link (116), and PDA (112) connects to network (101) through wireless link (114). In the example of FIG. 1, personal computer (108) connects through wireline connection (120) to WAN (101) and computer workstation (104) connects through wireline connection (122) to WAN (101).

In the example of FIG. 1, several exemplary devices including a laptop (126) and personal computer (102) are connected to LAN (101) and allow users to access resource on, retrieve resources from, and store resources on the file system (128). In the example of FIG. 1, laptop (126) connects through wireless link (118) to LAN (103), and personal computer (102) connects through wireline connection (124) to LAN (103).

The arrangement of servers and other devices making up the exemplary distributed processing system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP/IP, HTTP, WAP, HDTP, and others as will occur to those of skill in the art. Various embodiments of the present invention may be implemented on a variety of hardware platforms in addition to those illustrated in FIG. 1.

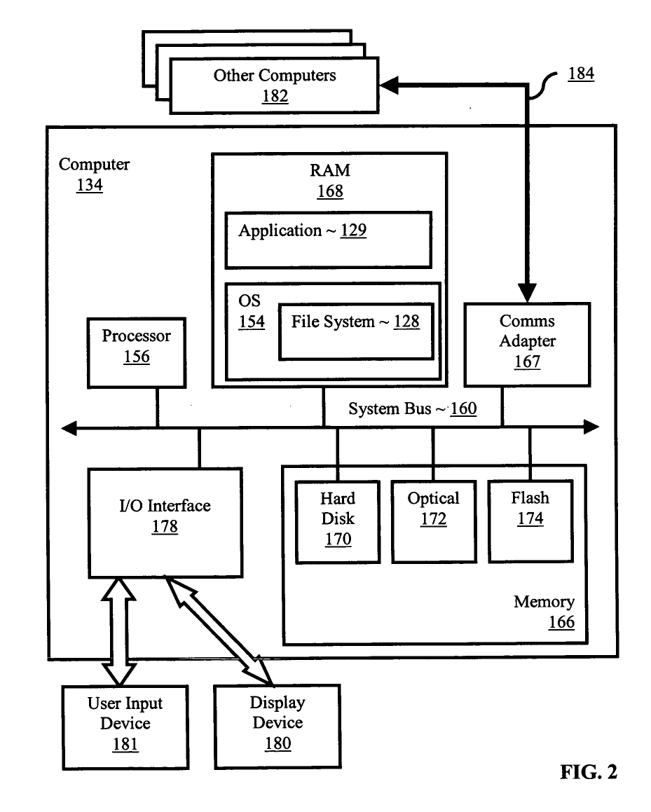

As mentioned above, disk quota management with limits classes in accordance with the present invention is generally implemented with computers, that is, with automated computing machinery. For further explanation, FIG. 2 sets forth a block diagram of automated computing machinery comprising a computer (134) useful in disk quota management with limits classes according to embodiments of the present invention. The computer (134) of FIG. 2 includes at least one computer processor (156) or ‘CPU’ as well as random access memory (168) (“RAM”). Stored in RAM (168) is an application (129). Application programs useful in accordance with various embodiments of the present invention include word processors, spreadsheets, database management systems, as well as many others that will occur to those of skill in the art.

Also stored in RAM (168) is an operating system (154). The operating system of FIG. 1 also includes a file system (128) that is capable of disk quota management in accordance with the present invention. The file system is capable of assigning a user to a limits class, receiving, from a user, a request to store a resource on the file system, and determining whether to allow the user to store the resource on the file system in dependence upon the limits class to which the user is assigned and the current disk usage of the user. Operating systems supporting file systems capable of modification to perform disk quota management with limits classes in accordance with the present invention include Unix, AIX™, Linux™, Microsoft NT™, and others as will occur to those of skill in the art. Operating system (154) in the example of FIG. 2 is shown in RAM (154), but many components of an operating system typically are stored in non-volatile memory (166) also.

The computer (134) of FIG. 2 includes non-volatile computer memory (166) coupled through a system bus (160) to a processor (156) and to other components of the computer. Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary computer (134) of FIG. 2 also includes a communications adapter (167) for implementing connections for data communications (184), including connections through networks, to other computers (182), including servers, clients, and others as will occur to those of skill in the art. Communications adapters implement the hardware level of connections for data communications through which local devices and remote devices or servers send data communications directly to one another and through networks. Examples of communications adapters include modems for wired dial-up connections, Ethernet (IEEE 802.3) adapters for wired LAN connections, and 802.11b adapters for wireless LAN connections.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

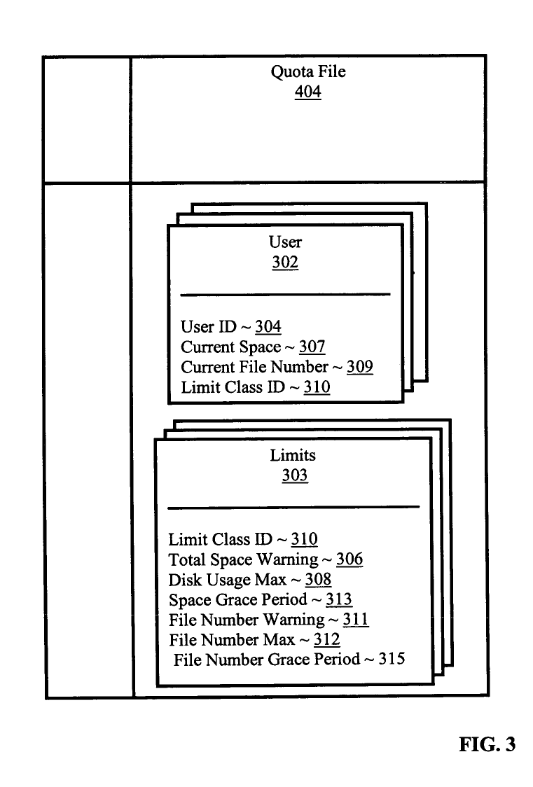

File systems modified to implement disk quota management with limits classes according to embodiments of the present invention often maintain a quota file that contains user records and limits records. For further explanation, FIG. 3 sets forth a line drawing of an exemplary quota file (404) useful in implementing disk quota management in accordance with embodiments of the present invention. The exemplary quota file (404) of FIG. 3 includes a plurality of user records (302) representing users currently governed by disk quota management. The exemplary user records (302) of FIG. 3 include a user ID (304) uniquely identifying the user. The exemplary user records (302) of FIG. 3 also include a current space (307) field that contains the disk space currently allocated to the user. That is, the current disk usage of the user. The exemplary user records (302) of FIG. 3 includes a current number of files (309) that contains the number of resources currently stored on the file system by the user. The user records (302) of FIG. 3 also include a limits class ID field (310) which uniquely identifies the limits class.

The exemplary quota file (404) of FIG. 3 also includes a plurality of limits records (303) each of which implement a limits class. The exemplary limits records (303) of FIG. 3 include a limits class ID uniquely identifying the limits class. The exemplary limits records (303) of FIG. 3 include a total space warning field (306) that represents a disk space threshold resulting in issuing warning to a user thereby notifying the user that additional disk space for the user's use is currently limited. Exceeding the disk space warning threshold typically does not result in denying a user's request to store a resource, but instead results in issuing a user a warning. The limits class (303) of FIG. 3 also includes space grace period field (313) which includes a period of time that a user is allowed to exceed the total space warning threshold.

The exemplary limits records (303) of FIG. 3 includes a disk usage maximum field (308) that contains a maximum disk space threshold beyond which a user's request to store additional resources is denied. The exemplary limits records (303) of FIG. 3 also include a file number warning field (311) that represents a threshold resulting in issuing a warning to a user thereby notifying the user that the number of additional resources that the user will be allow ed to store in the file system is currently limited. Exceeding the file number warning typically does not result in denying a user's request to store a resource, but instead results in issuing the user a warning. The exemplary limits records (303) of FIG. 3 also includes a total file number maximum field (312) that contains a maximum number of resources that a user can store in the file number beyond which a user's request to store additional resources is denied. The limits class (303) of FIG. 3 also includes file number grace period field (315) which includes a period of time that a user is allowed to exceed the file number warning threshold.

In example of FIG. 3, the limits records (303) and the user records (302) are stored in the quota file (404) which is in turn stored in a file system. Such a structure is for explanation and not for limitation. In fact, disk quota management with limits class may be implemented by separately storing the limits records in a limits file in a file system and the user records in a quota file in the file system. Disk quota management with limits class may also be implemented by storing limits records as extended attributes to a quota file in a file system. These exemplary storage arrangements of the user records and the limits records are for explanation only, and any storage arrangement of the user records and the limits records are well within the scope of the present invention.

The exemplary limits records of FIG. 3 advantageously allows a system administrator to update a single limits record to change the limits requirements of all users assigned to that limits class. The exemplary limits records of FIG. 3 also provide systems administrators the ability to efficiently establish default limit classes for users either by user attributes or system wide for all users. Separating user records and limits records results in increased flexibility and reduced burden on a systems administrator.

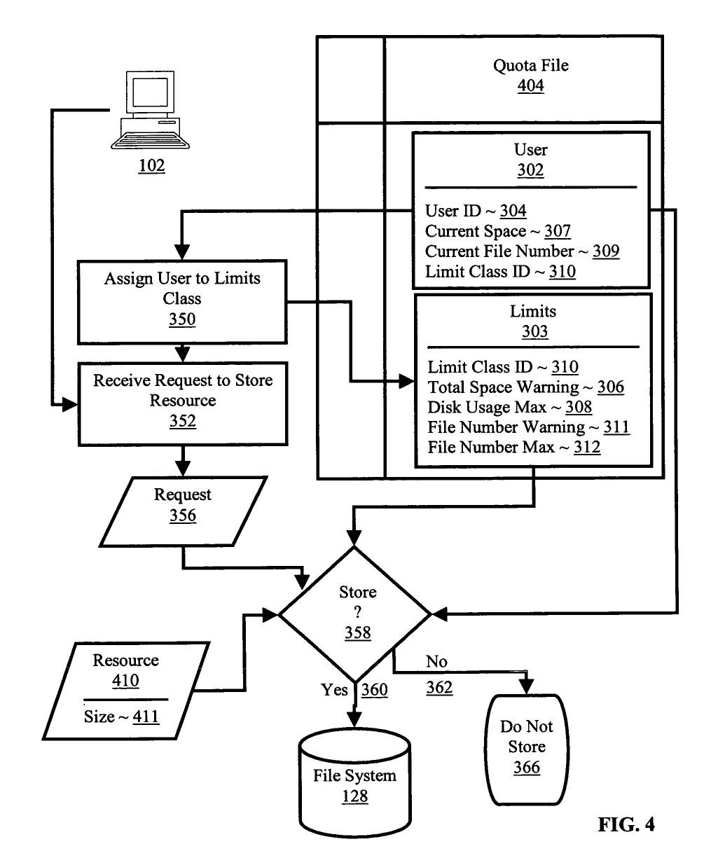

For further explanation, FIG. 4 sets forth a flow chart illustrating an exemplary method for disk quota management that includes assigning (350) a user (302) to a limits class (302). In the method of FIG. 4, assigning (350) a user (302) to a limits class (302) is typically carried out by a system administrator who determines an appropriate limits class for a user and provides within a user record an index to the appropriate limits record.

The method of FIG. 4 includes receiving (352), from a user, a request (356) to store a resource (410) and determining (358) whether to allow the user to store the resource (410) in dependence upon the limits class (303) and current disk usage of the user (302). In the method of FIG. 4, determining (358) whether to allow the user to store the resource (410) in dependence upon the limits class (303) and current disk usage of the user (302) is typically carried out by retrieving a user record for the user, identifying the limits class to which the user is assigned and determining whether the storing the requested resource will exceed the user's disk space allocation or file number allocation as defined in the user's limits class. If storing the resource does not (360) exceed the user's allocated disk space or exceed the user's allocated number of resources, then the method of FIG. 4 continues by storing the resource in the file system (128). In the method of FIG. 4, a user is denied (362) storage of the resource if storing the resource either exceeds the user's allocated disk space or exceeds the user's allocated number of resources.

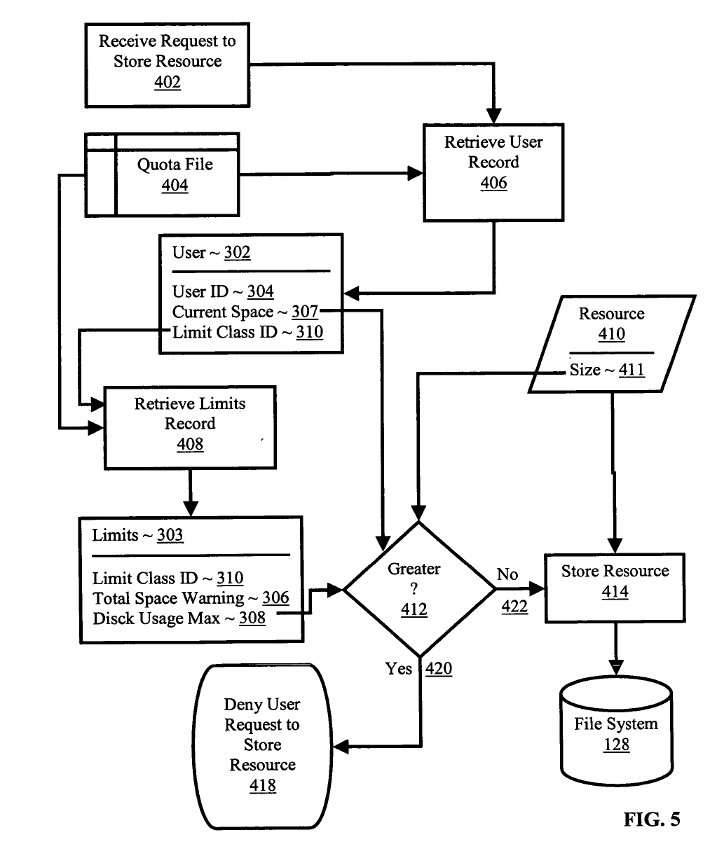

For further explanation therefore, FIG. 5 sets forth an exemplary method for determining whether to allow the user to store the resource in dependence upon the limits class and current disk usage of the user that includes a determination as to whether storing the resource will exceed the user's allocated disk space. The method of FIG. 5 includes retrieving (406) a user record (302) for the user. Retrieving (406) a user record (302) for the user is typically carried out by searching a quota file for a user record having a matching user ID.

The method of FIG. 5 also includes retrieving (408) a limits record (303) in dependence upon the user record (302). Retrieving (408) a limits record (303) in dependence upon the user record (302) is typically carried out by reading a limit class ID (310) from the user record (302) representing the limits class to which the user is assigned and then searching a quota file for a limits record having a matching limits class ID (310).

The method of FIG. 5 also includes comparing (412) the user's current disk space usage (307) in the user record (302) and the size (411) of the resource (410) with the disk space usage maximum (308) in the limits record (303). If the combination of the size of the resource (410) and the user's current disk space usage (307) do not (422) exceed the disk usage maximum (308) in the limits record (303), then the method of FIG. 5 continues by storing (414) the resource in the file system. If the combination of the size of the resource (410) and the user's current disk space usage (307) does (420) exceed the disk usage maximum (308) in the limits record (303), then the method of FIG. 5 continues by denying (418) the user's request to store the resource in the file system.

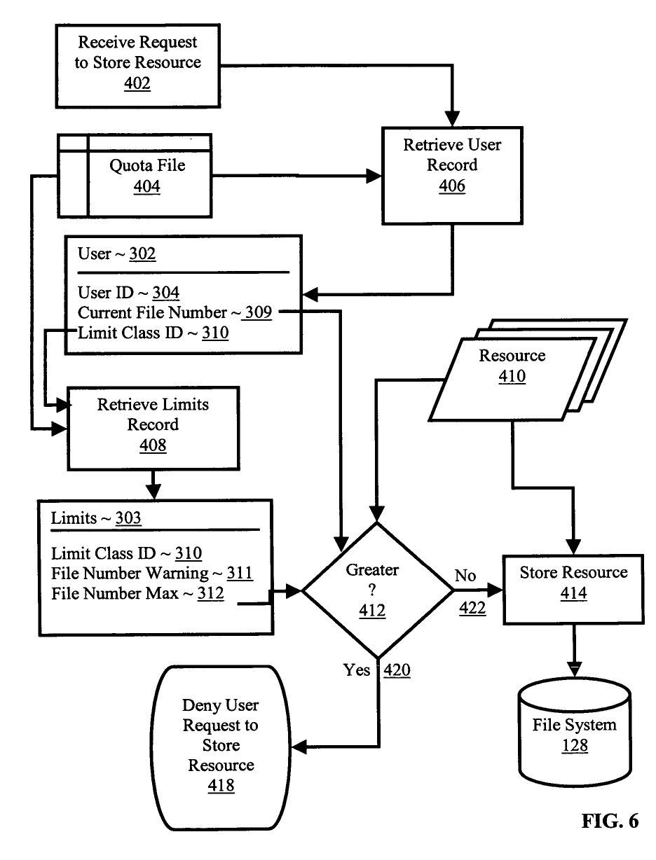

As discussed above, a user may also be denied a request to store a resource if storing the resource exceeds the user's allocated maximum number of resources. For further explanation, FIG. 6 sets forth a flow chart illustrating an exemplary method for determining whether to allow the user to store the resource in dependence upon the limits class and current disk usage of the user that includes retrieving (406) a user record (302) for the user. Retrieving (406) a user record (302) for the user is typically carried out by searching a quota file for a user record having a matching user ID.

The method of FIG. 6 includes retrieving (408) a limits record (303) in dependence upon the user record (302). Retrieving (408) a limits record (303) in dependence upon the user record (302) is typically carried out by reading a limit class ID from the user record representing the limits class to which the user is assigned and then searching a quota file for a limits record having a matching limits class ID (310).

The method of FIG. 6 includes comparing (412) the user's current number of files (309) in the user record (302) and a requested number of resources (410) to be stored with the file number maximum (312) in the limits record (303). If the combination of the number of resources (410) the user requests to store and the user's current number of files (309) do not (422) exceed the total file number maximum (312) in the limits record (303), then the method of FIG. 5 continues by storing (414) the resource in the file system (128). If the combination of the number of resources (410) the user is requesting to store and the user's current number of files (309) does (420) exceed the total file number maximum (312) in the limits record (303), then the method of FIG. 5 continues by denying (418) the user's request to store the resource in the file system.

Exemplary methods of disk quota management with limits classes as described with reference to FIGS. 4-6 advantageously provide a number of benefits.
System administrators may now establish default limits classes and new users may automatically be assigned to the default limits class.
Once users are assigned to a limits class a system administrator must only change the limits in the limits class to change disk quotas for all users having similar limits class assignments.
Overall disks space is conserved because the limits information is not duplicated in the quota record for every user.
Administration may be simplified by assigning a name to a limits class. The system administrator can then perform operations based on that name rather than remembering limits information for every user on the system.
System-wide limits classes and default limits classes advantageously reduce administration of new file systems. Users can be assigned to system-wide limits classes so that despite any file system-specific limits classes, the user is bound by the system limits class.
Limit class advantageously provide a vehicle to implement grace periods per class instead per file system.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for disk quota management, the method comprising:
assigning a user to a limits class;
receiving, from a user, a request to store a resource; and
determining whether to allow the user to store the resource in dependence upon the limits class and current disk usage of the user.

2. The method of claim 1 wherein determining whether to allow the user to store the resource in dependence upon the limits class and current disk usage of the user comprises:
retrieving a user record for the user;
retrieving a limits record in dependence upon the user record; and
comparing the user's current disk space usage in the user record and the size of the resource with the disk space usage maximum in the limits record.

3. The method of claim 1 wherein determining whether to allow the user to store the resource in dependence upon the limits class and current disk usage of the user comprises:
retrieving a user record for the user;
retrieving a limits record in dependence upon the user record;
comparing the user's current number files in the user record and a requested number of resources to be stored with the file number maximum in the limits record.

4. The method of claim 1 further comprising updating the limits record.

5. The method of claim 1 wherein the limits record and the user record are stored in a quota file in a file system.

6. The method of claim 1 wherein the limits record is stored in a limits file in a file system and the user record is stored in a quota file in the file system.

7. The method of claim 1 wherein the limits record is stored as an extended attribute to a quota file in a file system.

8. A system for disk quota management, the system comprising:
means for assigning a user to a limits class;
means for receiving, from a user, a request to store a resource; and
means for determining whether to allow the user to store the resource in dependence upon the limits class and current disk usage of the user.

9. The system of claim 8 wherein means for determining whether to allow the user to store the resource in dependence upon the limits class and current disk usage of the user comprises:
means for retrieving a user record for the user;
means for retrieving a limits record in dependence upon the user record; and
means for comparing the user's current disk space usage in the user record and the size of the resource with the disk space usage maximum in the limits record.

10. The system of claim 8 wherein means for determining whether to allow the user to store the resource in dependence upon the limits class and current disk usage of the user comprises:
means for retrieving a user record for the user;
means for retrieving a limits record in dependence upon the user record;
means for comparing the user's current number of files in the user record and a requested number of resources to be stored with the file number maximum in the limits record.

11. The system of claim 8 further comprising means for updating the limits record.

12. The system of claim 8 wherein the limits record and the user record are stored in a quota file in a file system.

13. The system of claim 8 wherein the limits record is stored in a limits file in a file system and the user record is stored in a quota file in the file system.

14. The system of claim 8 wherein the limits record is stored as an extended attribute to a quota file in a file system.

15. A computer program product for disk quota management, the computer program product comprising:
a recording medium;
means, recorded on the recording medium, for assigning a user to a limits class;
means, recorded on the recording medium, for receiving, from a user, a request to store a resource; and
means, recorded on the recording medium, for determining whether to allow the user to store the resource in dependence upon the limits class and current disk usage of the user.

16. The computer program product of claim 15 wherein means, recorded on the recording medium, for determining whether to allow the user to store the resource in dependence upon the limits class and current disk usage of the user comprises:
means, recorded on the recording medium, for retrieving a user record for the user;
means, recorded on the recording medium, for retrieving a limits record in dependence upon the user record; and
means, recorded on the recording medium, for comparing the user's current disk space usage in the user record and the size of the resource with the disk space usage maximum in the limits record.

17. The computer program product of claim 15 wherein means, recorded on the recording medium, for determining whether to allow the user to store the resource in dependence upon the limits class and current disk usage of the user comprises:
means, recorded on the recording medium, for retrieving a user record for the user;
means, recorded on the recording medium, for retrieving a limits record in dependence upon the user record;
means, recorded on the recording medium, for comparing the user's current number of files in the user record and a requested number of resources to be stored with the file number maximum in the limits record.

18. The computer program product of claim 15 further comprising means, recorded on the recording medium, for updating the limits record.

19. The computer program product of claim 15 wherein the limits record and the user record are stored in a quota file in a file computer program product.

20. The computer program product of claim 15 wherein the limits record is stored in a limits file in a file computer program product and the user record is stored in a quota file in the file computer program product.
